(19) United States
(12) Patent Application Publication
(10) Pub. No.: US 2019/0061206 A1
(43) Pub. Date: Feb. 28, 2019

(54) COMPOSITE ARTICLE MOLDING

(71) Applicant: Ford Global Technologies, LLC, Dearborn, MI (US)

(72) Inventors: Jeffrey Scott DAHL, Livonia, MI (US); Michael Musa AZZOUZ, Livonia, MI (US)

(21) Appl. No.: 15/691,910

(22) Filed: Aug. 31, 2017

(51) Int. Cl. B29C 43/36; B29C 43/18

(52) U.S. Cl. CPC B29C 43/36; B29C 2043/3602; B29C 43/18

(57) ABSTRACT

A compression molding assembly is provided. The compression molding assembly includes a lower assembly defining a cavity. The compression molding assembly also includes an upper assembly disposed opposite the lower assembly. The upper assembly defines a slotted interface having a slot extending into the upper assembly for receiving an out-of-plane portion of an insert component. The upper assembly further includes a magnetic locator pin for engaging an in-plane portion of the insert component.

### TECHNICAL FIELD

This disclosure relates to molding a composite article, and more particularly, to molding a composite article having a metallic insert.

### BACKGROUND

Composite articles are well known to provide advantages in diverse applications including, for example, body panels and other components for motor vehicles. In some applications, the advantages of composite articles over metal, ceramic or other materials include weight reduction and the ability to integrate several otherwise individual parts into a single structure. Composite articles of this nature comprise reinforcement material in a polymer based resin, such as a thermoplastic or a thermoset plastic, which is moldable in a first condition but curable (for example, by cooling below the softening point in the case of a thermoplastic) to a form-stable condition. Numerous reinforcement materials are well known to those skilled in the art including, for example, chopped or continuous fibers disposed either randomly or in ordered fashion within the matrix. Exemplary composite materials include a “pre-impregnated” (or “prepreg”) composite material, sheet molding compound (SMC) (typically comprising chopped glass fibers in a thermoset resin), and bulk molding compound (BMC) (typically comprising a granulated or putty-like mixture of chopped fibers in a polymer based resin).

### SUMMARY

In at least one approach, a compression molding assembly is provided. The compression molding assembly may include a lower assembly defining a cavity. The compression molding assembly may also include an upper assembly disposed opposite the lower assembly. The upper assembly may define a slotted interface having a slot extending into the upper assembly for receiving an out-of-plane portion of an insert component. The upper assembly may further include a magnetic locator pin for engaging an in-plane portion of the insert component.

In at least one approach, a method of forming an overmold assembly in a compression molding assembly is provided. The method may include disposing a first molding material in a lower assembly. The method may further include disposing a second molding material on a top surface of an in-plane portion of an insert component. The method may further include inserting an out-of-plane portion of the insert component into a slotted region of an upper assembly. The method may further include engaging a magnetic locator pin with the top surface of the in-plane portion of the insert component.

### BRIEF DESCRIPTION OF THE DRAWINGS

FIG. 1 is a top perspective view of a compression molding assembly.

FIG. 2 is an exploded bottom perspective view of the compression molding assembly.

FIG. 3 is a plan view of an upper assembly of the compression molding assembly.

FIG. 4 is a perspective view of an exemplary overmold assembly formed by the compression molding assembly.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

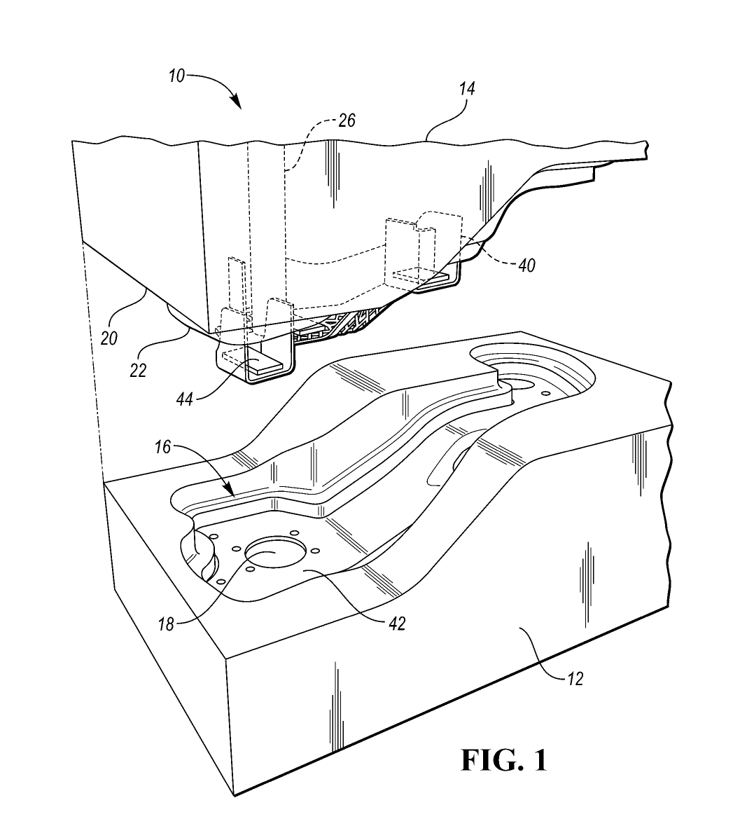

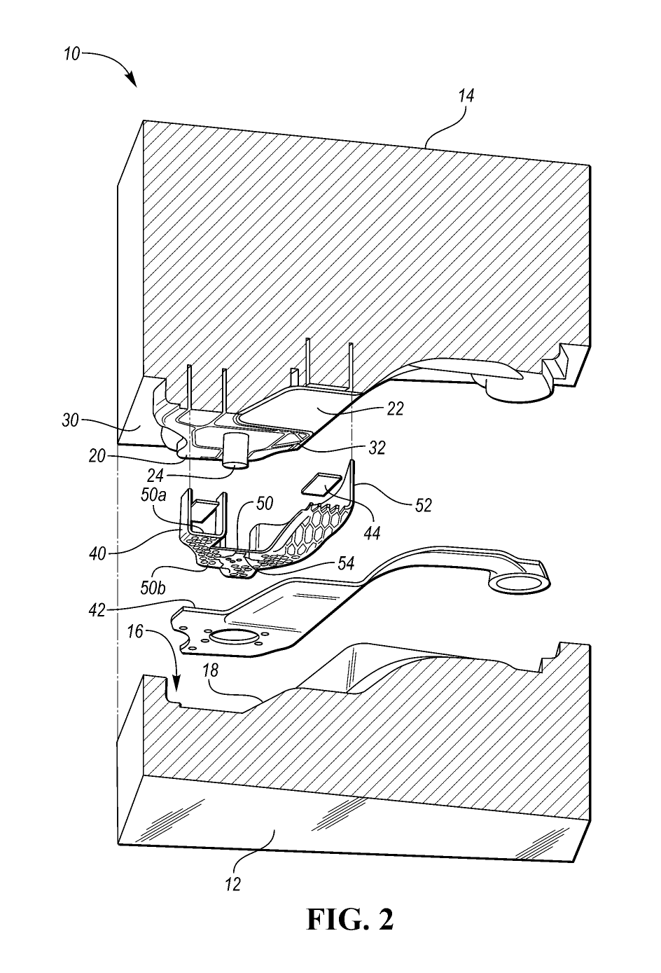

Referring now to FIGS. 1 and 2, a compression molding assembly or system 10 includes a first assembly 12 and a second assembly 14. As shown herein, the second assembly 14 may be disposed above the first assembly 12. In this way, the first assembly 12 may be referred to as a lower assembly 12, and the second assembly 14 may be referred to as an upper assembly 14.

In use, the upper and lower assemblies 12, 14 may be separated to allow an operator to insert one or more molding materials and components for forming an overmold assembly between the upper and lower assemblies 12, 14. The compression molding assembly 10 may then be closed such that the upper and lower assemblies 12, 14 engage the molding materials and components. While closed, the compression molding assembly 10 may heat the molding materials and may also provide compressive forces to mold the molding materials into the desired form.

In one approach, the lower assembly 12 is fixed, and the upper assembly 14 is moveable relative to the lower assembly 12; for example, by lowering the upper assembly 14 to engage the lower assembly 12 and raising the upper assembly 14 to disengage from the lower assembly 12. In another approach, the upper assembly 14 is fixed, and the lower assembly 12 is movable relative to the upper assembly 14; for example, by raising the lower assembly 12 to engage the upper assembly 14 and lowering the lower assembly 12 to disengage from the upper assembly 14. In still another approach, the upper and lower assemblies 12, 14 are both movable relative to each other.

The lower assembly 12 may define a cavity 16. The cavity 16 may be sized to receive a molding material, as discussed in greater detail elsewhere herein. The cavity 16 may define a molding surface 18 having a geometry corresponding to a bottom portion of a desired article of manufacture.

The upper assembly 14 may include a stop surface 20 for engaging the lower assembly 12. The upper assembly 14 may further include a molding body 22 (also referred to as a press, punch, or plug) extending from the stop surface 20 in the direction of the lower assembly 12. The molding body 22 may have a geometry corresponding to an upper portion of a desired article of manufacture.

A locator pin 24 may extend within and, in some configurations, through the upper assembly 14. The locator pin 24 may be adapted to aid a user in aligning an insert component relative to the upper assembly 14, as discussed in greater detail elsewhere herein. In at least one approach, the locator pin 24 is a magnetic locator pin. The locator pin 24 may be formed of a ferromagnetic metal, rare earth metal (e.g., neodymium), or composite (e.g., ferrite), and may be a permanent magnet. The magnetic locator pin 24 may have any suitable shape, such as a disc or bar.

The locator pin 24 may be axially movable relative to the upper assembly 14. For example, the locator pin 24 may be axially movable between an extended position and a retracted position. In the extended position, an end portion of the locator pin 24 may protrude out of the upper assembly 14; for example, beyond an exterior surface of the molding body 22. In the retracted position, the end portion of the locator pin 24 may be disposed in proximity to the upper assembly 14; for example, adjacent to, flush with, or retracted within the exterior surface of the molding body 22. The locator pin 24 may be actuated by any actuation device; for example, a charged gas (e.g., nitrogen) cylinder, a hydraulic cylinder, or an ejector plate actuated via a charged gas or hydraulics. The actuator may be programmed to function with press closure (e.g., via press control), or may be actuated by to one-way cylinders that permit the locator pin 24 to retract due to closure of the compression molding assembly 10.

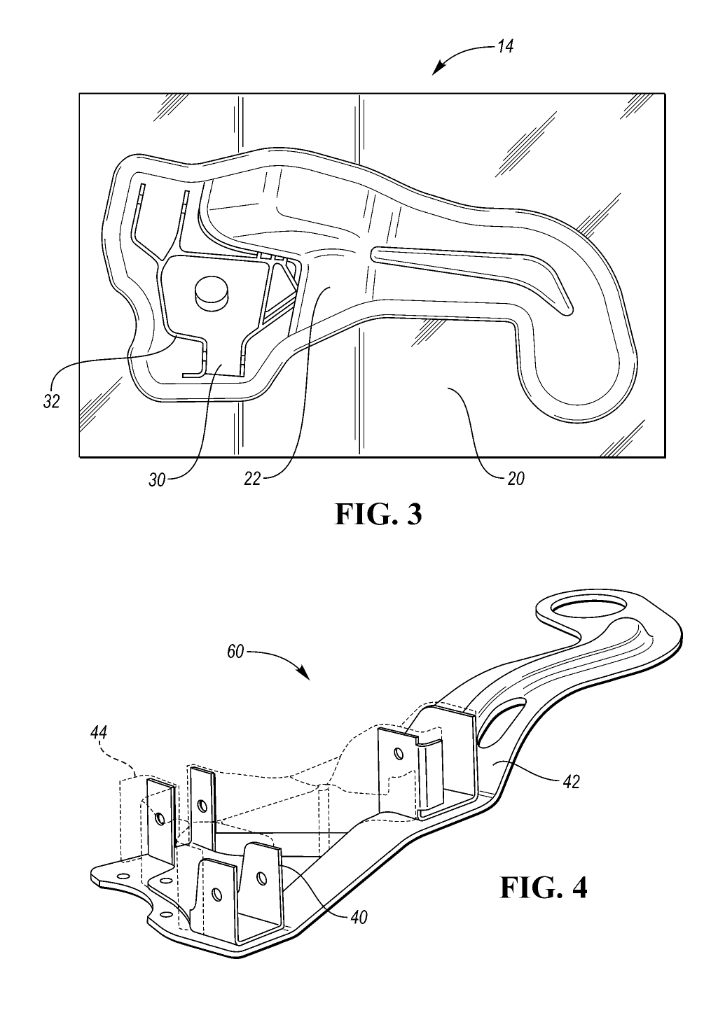

Referring momentarily to FIG. 3, at least a portion of the molding body 22 may include a slotted interface 30. The slotted interface 30 may include one or more slots 32. In at least one approach, the slotted interface 30 includes an elongated, continuous slot 32. The slot 32 may have a depth that extends into the upper assembly 14; for example, into the molding body 22. The slot 32 may have a width that is greater than the width of an out-of-plane portion of an insert component, as discussed in greater detail elsewhere herein. In at least one approach, the slot 32 has a width along a portion or along the entire slot 32 such that when the insert component is secured to the upper assembly 14, the slot 32 forms gaps on opposing sides of the out-of-plane portion of the insert component. In this way, the continuous slot 32 may extend about at least a portion of a perimeter of the insert component when the insert component is received within the continuous slot 32.

As shown in FIGS. 1 and 2, an insert component 40, a first molding material 42, and a second molding material 44 may be disposed between the lower assembly 12 and the upper assembly 14. The molding materials may be thermoset material or thermoplastic material. In one approach, the first molding material 42 is different than the second molding material 44. For example, the first molding material 42 may be a prepreg composite material having a matrix material and a fiber, filler, or other reinforcement material. The prepreg composite may be partially cured prior to insertion in the cavity 16. The second molding material 44 may be a sheet molding composite (SMC) material. An SMC sheet or body may be comprised of a resin paste and chopped glass fibers between sheets of carrier films. In this way, the compression molding assembly 10 may be a co-compression molding assembly suitable for compression molding discrete molding materials.

The insert component 40 may have an in-plane portion 50 and an out-of-plane portion 52. The in-plane portion 50 may be a generally horizontal portion having a bottom surface 50a adapted to engage the first molding material 42, and a top surface 50b adapted to receive the second molding material 44. The in-plane portion 50 may also include sloped portions adapted to engage the first molding material 42. In at least one approach, the in-plane portion 50 defines a discontinuous (e.g., mesh) surface.

The out-of-plane portion 52 may be comprised of walls extending generally orthogonal to the in-plane portion 50. The out-of-plane portion 52 may define continuous upstanding walls, or may define discontinuous (e.g., mesh) upstanding walls. In at least one approach, the out-of-plane portion 52 includes one or more pairs of opposing upstanding walls.

The insert component 40 may include a locating feature 54 for interfacing with the locator pin 24. The locating feature 54 may be a generally planar locating feature. The locating feature 54 may, for example, include a circular locating feature having one or more tabs extending from the circular locating feature and engaging the discontinuous (e.g., mesh) surface of the insert component 40.

The insert component 40 may be a metallic insert component that may be magnetically couplable with the locator pin 24. For example, the metallic insert component may be formed of steel. The magnetic coupling may be such that the locator pin 24 may hold the insert component 40 in a suspended configuration; for example, above the lower assembly 12.

The compression molding assembly 10 may be adapted to form an overmold assembly comprised of the insert component 40, the first molding material 42, and the second molding material 44.

In use, the first molding material 42 may be disposed in the lower assembly 12, and more particularly, in the cavity 16 formed in the lower assembly 12.

The second molding material 44 may be disposed on the insert component 40. For example, the second molding material 44 may be disposed on the top surface 50b of the in-plane portion 50 of the insert component 40. In at least one approach, the second molding material 44 is disposed on between the upstanding walls of the out-of-plane portion 52.

The insert component 40 may engage the upper assembly 14. In at least one approach, at least a portion of the out-of-plane 52 portion of the insert component 40 may be inserted into the slotted interface 30 (e.g., into the slot 32 of the slotted interface 30) of the upper assembly 14. As previously described, the slot 32 has a width along a portion or along the entire slot 32 such that when the insert component 40 is secured to the upper assembly 14, the slot 32 forms gaps on opposing sides of the out-of-plane portion 52 of the insert component 40.

The insert component 40 may also be secured to the upper assembly 14. In at least one approach, the top surface 50b of the in-plane portion 50 of the insert component 40 is brought into engagement with the locator pin 24. For example, the locating feature 54 of the insert component 40 may be brought into engagement with the locator pin 24. In this way, the insert component 40, and the second molding material 44 disposed on the insert component 40, may be aligned relative to the first molding material 42 disposed in the cavity 16 of the lower assembly 12.

At least one of the upper assembly 14 and the lower assembly 12 may be moved to close the compression molding assembly 10. In this way, the bottom surface 50a of the in-plane portion 50 of the insert component 40 may engage the first molding material 42.

The locator pin 24 may be retracted from an extended position, in which the locator pin 24 is engaged with the insert component 40, to a retracted position, in which the locator pin 24 is no longer in engagement with the insert component 40.

The compression molding assembly 10 may be actuated to heat the second molding material 44 to cause the second molding material 44 to flow across the insert component 40. For example, the second molding material 44 may flow across the in-plane region 50 of the insert component 40. The second molding material 44 may also flow along the out-of-plane region 52 of the insert component 40. For example, the second molding material 44 may also flow along the upstanding walls of the out-of-plane region 52 into the slot 32 formed in the slotted interface 30 of the molding body 22. As previously discussed, the slot 32 forms gaps on opposing sides of the out-of-plane portion 52 when the insert component 40 is disposed in engagement with the upper assembly 14. Heat may be applied during a curing stage of the second molding material 44.

Upon curing of the second molding material 44, at least one of the upper assembly 14 and the lower assembly 12 may be moved to open the compression molding assembly 10 to facilitate removal of the overmold assembly. In at least one approach, the locator pin 24 may be axially moved to displace the overmold assembly relative to the upper assembly 14. For example, the locator pin 24 may be axially moved from the retracted position to the extended position.

Referring to FIG. 4, a formed overmold assembly 60 may include the insert component 40, the first molding material 42, and the second molding material 44. The second molding material 44 may be formed about the insert component 40 and may be molded to the first molding material 42. The insert component 40 may be formed of a suitable material to provide increased structural rigidity to the overmold assembly 60 as compared to a body component without an insert component.

The overmold assembly 60 formed by the compression molding assembly 10 may be a vehicle component. For example, the overmold assembly 60 may be a tie blade arm. Other various kinds of structural automotive components are expressly contemplated; such as body panels (e.g., hoods, fenders, decklids, pickup boxes, pillars, lift gates, and roofs), engine components (e.g., valve covers and oil pans), vehicle frame elements, bumper beams, fan shrouds, and many other types of components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A compression molding assembly comprising:
a lower assembly defining a cavity; and
an upper assembly disposed opposite the lower assembly, the upper assembly defining a slotted interface having a slot extending into the upper assembly for receiving an out-of-plane portion of an insert component, and a magnetic locator pin for engaging an in-plane portion of the insert component.

2. The compression molding assembly of claim 1, wherein the upper assembly defines a stop surface for engaging the lower assembly, and a molding body extending from the stop surface in a direction of the lower assembly.

3. The compression molding assembly of claim 2, wherein the slotted interface is formed in at least a portion of the molding body.

4. The compression molding assembly of claim 1, wherein the slot defines a continuous slot extending about at least a portion of a perimeter of the insert component when the insert component is received within the continuous slot.

5. A method of forming an overmold assembly in a compression molding assembly, comprising:
disposing a first molding material in a lower assembly;
disposing a second molding material on a top surface of an in-plane portion of an insert component;
inserting an out-of-plane portion of the insert component into a slotted region of an upper assembly; and
engaging a magnetic locator pin with the top surface of the in-plane portion of the insert component.

6. The method of claim 5, wherein the second molding material is disposed on the top surface between walls of the out-of-plane portion of the insert component.

7. The method of claim 5, wherein the second molding material is different than the first molding material.

8. The method of claim 7, wherein the first molding material is a sheet molding compound, and wherein the second molding material is a prepreg composite material.

9. The method of claim 5, wherein the insert component is a metallic insert component magnetically couplable to the magnetic locator pin.

10. The method of claim 5, further comprising:
moving at least one of the upper assembly and the lower assembly to close the compression molding assembly and engage a bottom surface of the in-plane portion of the insert component with the first molding material.

11. The method of claim 10, further comprising:
axially moving the magnetic locator pin from an extended position to a retracted position.

12. The method of claim 11, further comprising:
applying heat to the second molding material to cause the second molding material to flow into a slot of the slotted region of the upper assembly.

13. The method of claim 12, further comprising:
moving at least one of the upper assembly and the lower assembly to open the compression molding assembly to facilitate removal of the overmold assembly, the overmold assembly comprising the first molding material, the second molding material, and the insert component.

14. The method of claim 13, further comprising:
axially moving the magnetic locator pin from the retracted position to the extended position to displace the overmold assembly relative to the upper assembly.

15. An upper assembly for a compression molding assembly comprising:
a molding body adapted to be received in a cavity of a lower assembly, the molding body defining a slotted interface having a slot extending into the molding body for receiving an out-of-plane portion of an insert component; and
a magnetic locator pin for engaging an in-plane portion of the insert component.

16. The upper assembly of claim 15, wherein the upper assembly defines a stop surface for engaging the lower assembly, wherein the molding body extends from the stop surface in a direction of the lower assembly.

17. The upper assembly of claim 16, wherein the slotted interface is formed in at least a portion of the molding body.

18. The upper assembly of claim 15, wherein the slot defines a continuous slot extending about at least a portion of a perimeter of the insert component when the insert component is received within the continuous slot.
